(19) United States
(12) Patent Application Publication
(10) Pub. No.: US 2011/0085116 A1
(43) Pub. Date: Apr. 14, 2011

(54) DUAL LAYER HOLOGRAPHIC COLOR FILTER AND TRANSMISSIVE LIQUID CRYSTAL DISPLAY USING THE SAME

(76) Inventor: Eun-Seok Kim, Cheongju-City (KR)

(21) Appl. No.: 12/716,957

(22) Filed: Mar. 3, 2010

(30) Foreign Application Priority Data
Oct. 14, 2009 (KR) 10-2009-0097800

(51) Int. Cl. G02F 1/1335; G02B 5/32

(52) U.S. Cl. 349/106; 359/15

(57) ABSTRACT

A dual layer holographic color filter and a transmissive liquid crystal display using the same. The dual layer holographic color filter includes a first hologram, which is provided between a light source and the liquid crystal display to spatially split white light from a substrate at the side of the light source, and a second hologram, which allows the split light to have the same direction as that of the light from the light source, to receive only light having a spectral bandwidth corresponding to colored cells of a color filter, so that the luminance of the liquid crystal display is enhanced. Light passing through the first hologram including hologram pieces is diffracted at different angles according to wavelengths. The second hologram recovers the traveling direction of the white light spatially split in the first hologram to an original direction of light from the light source.

### FIELD OF INVENTION

The present invention relates to a dual layer holographic color filter and a transmissive LCD using the same, and more particularly to a dual layer holographic color filter and a transmissive LCD using the same, which adopt an optical device and a structure adaptable for the LCD using the optical device, and in which light efficiency can be improved by allowing only light having a wavelength band, which is suitable for RGB color filters, to be incident onto the RGB color filters of the LCD such that an amount of light absorbed by the RGB color filters can be minimized and color reproduction can be enhanced by preventing the wavelengths from overlapping each other between the RGB color filters.

### BACKGROUND

Generally, since 90% of light supplied from a backlight is absorbed by a polarizing plate and color filters, a liquid crystal display (LCD) represents very low light efficiency. Particularly, since the RGB color filters manufactured by using dyes or pigments selectively transmit only light having wavelength of white light corresponding to the RGB color filters, the maximum efficiency is at most 33%. In addition, since the RGB color filters do not properly perform a filtering function, a bandwidth may be broadened.

In order to solve the problem, U.S. Pat. No. 5,506,701/6,473,144 B1 suggests a method of preparing the array of holograms with the size of a unit pixel performing a lens function, spatially splitting wavelengths having RGB bandwidths due to chromatic dispersion, and then allowing the wavelengths to be incident onto sub pixels corresponding to the wavelengths. In addition, U.S. Pat. No. 7,046,407 B2 suggests a method of preparing two holograms and the array of lens disposed between the two holograms, collecting light having each wavelength corresponding to each colored cell by a lens having the size of a pixel, and correcting an optical path to an original state by one hologram if white light has been dispersed by the other hologram.

U.S. Pat. No. 5,894,359 suggests a method of dispersing color by using the grating of one hologram and employing a hologram serving as a 3-layer lens to collect light of RGB wavelengths in response to the RGB wavelengths, so that the light is incident onto each colored cell.

As shown in FIG. 1, according to the method disclosed in the U.S. Pat. No. 5,506,701, after white light from a backlight 3 has passed through a Fresnel zone plate, which is a hologram 5 having the size of a single pixel and operating as a lens, light having RGB wavelengths is selectively incident onto each of RGB colored cells 1′ of a color filter 1 of a liquid crystal 10. In this case, since the Fresnel zone plate is used, a circular focus is formed around each colored cell 1′ of the color filter 1. Accordingly, the liquid crystal 10 cannot perfectly rotate the polarization of light, and problems may occur in color combination due to chromatic dispersion in which split RGB wavelengths travel in different directions.

The U.S. Pat. No. 6,473,144 B1 discloses the same structure as that of the U.S. Pat. No. 5,506,701 except that a beam is incident onto a color filter in an oblique direction instead of a perpendicular direction. In detail, according to the U.S. Pat. No. 6,473,144 B1, the array of micro-holograms serving as a lens is employed, and a focus is formed around a liquid crystal. As a result, the polarized light cannot be perfectly rotated, and problems still remain in color combination due to chromatic dispersion after color split.

As shown in FIG. 2, according to the method disclosed in the U.S. Pat. No. 7,046,407 B2, after white light from a light source 14 is split according to wavelengths by one typical grating 16, RGB wavelengths are split corresponding to the size of a pixel by passing through a micro-lens 18 having the size of a pixel, and then each wavelength is recovered to an original direction before the grating 16 by passing through the other grating such that the wavelength is incident on an LCD 20. However, since this method is suitable for a transmissive LCD projector, the distance between the gratings 16 and 22 is greatly required. Accordingly, manufacturing the micro-lens 18 interposed between the gratings 16 and 22 is difficult, and the three devices hard to be aligned.

As shown in FIG. 3, according to the method disclosed in the U.S. Pat. No. 5,894,359, while white light F1 from a backlight is passing through a first hologram 16, the traveling direction of wavelengths of the white light F1 is changed due to light diffraction. Thereafter, among wavelengths arriving at a second hologram 14 serving as a lens, red, green, and blue wavelength are focused on preset positions by red, green, and blue holograms 14R, 14G, and 14B, respectively. According to this method, since the red, green, and blue wavelengths are focused in the same direction, problems related to color combination caused by chromatic dispersion can be solved. However, through this method, the second hologram 14 serving as a lens and having three layers cannot be realized in the unit of a pixel. In addition, as a hologram layer is increased, light absorption is increased.

### SUMMARY

In order to solve the above problems, the present invention suggests that only red, green, and blue wavelengths to be exclusively incident on their respective red (R), green (G), and blue (B) colored cells of a color filter in a transmissive liquid crystal display instead of the incidence of white light including all wavelengths, thereby solving a problem in which two-thirds of an amount of light are reduced in the color filter so that light efficiency can be improved. To this end, there is provided a dual layer holographic color filter including a pair of holograms and a method of constructing a liquid crystal display by using a dual layer holographic color filter.

In order to accomplish the object of the present invention, according to one aspect of the present invention, there is provided dual layer holographic color filter including a first hologram adjacent distributing wavelengths of white light to a space having a size of a unit pixel, a substrate supporting the first hologram and providing a diffraction space, a second hologram recovering a direction of wavelengths split by the first hologram into an original direction such that only a wavelength corresponding to each colored cell is incident onto the colored cell, thereby preventing problems in color combination.

According to another aspect of the present invention, in a liquid crystal display including a color filter, a dual layer holographic color filter is interposed between a light source and the color filter.

According to still another aspect of the present invention, in a liquid crystal display that does not include a color filter, a dual layer holographic color filter is interposed between a light source and a liquid crystal of the liquid crystal display.

As described above, according to the present invention, a liquid crystal display having low power consumption and representing superior color reproduction can be realized because light absorbed in a color filter can be fully used without causing the overlap of wavelengths. In addition, according to the present invention, there is provided an optical device, which can be actually realized and can solve optical problems by correcting the problems occurring in a conventional color-separation type color filter. The present invention can provide the dual layer holographic color filter and the transmissive LCD using the same, which can be designed and manufactured suitably for the type and the characteristics of a light source, so that the brightness can be improved in all of liquid crystal displays, thereby reducing power consumption. In addition, upon substitution for a color filter, three process steps of manufacturing red, green, blue color filters can be replaced with two process steps of manufacturing first and second holograms, so that processes can be reduced and equipment can be simplified.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 illustrates a reference view of U.S. Pat. No. 5,50,6701 in order to explain a related art;

FIG. 2 illustrates a reference view of U.S. Pat. No. 7,046,407 B2 in order to explain a related art;

FIG. 3 illustrates a reference view of U.S. Pat. No. 5,894,359 in order to explain a related art;

FIG. 4 is a view showing a transmissive liquid crystal display employing a dual layer holographic color filter according to the present invention;

FIGS. 5A and 5B are views showing a method of manufacturing a surface-relief hologram having a multi-layer through a CGH scheme when a holographic color filter according to the present invention is manufactured;

FIG. 6 is a view showing a method of directly recording a volume hologram on a recording material when a holographic color filter according to the present invention is manufactured;

FIG. 7 is a view showing the position of a reconstructed image of each wavelength on the surface of a second hologram after the wavelength has passed through a substrate by a first hologram piece in a dual layer holographic color filter according to the present invention;

FIG. 8 is a view showing the operating characteristic of a second hologram of correcting traveling directions of wavelengths, which are dispersed by a first hologram, in a dual layer holographic color filter according to the present invention;

FIGS. 9A to 9D are views showing a dual layer holographic color filter according to embodiments of the present invention;

FIG. 10A is a view showing the alignment of a first hologram of a dual layer holographic color filter according to the present invention, in which reconstructed images of the first hologram are suitable for an transmissive LCD equipped with color filters arranged in the form of a stripe;

FIG. 10B is a view showing the alignment of a first hologram of a dual layer holographic color filter according to the present invention, in which reconstructed images of the first hologram are suitable for an transmissive LCD equipped with color filters arranged in the form of a mosaic;

FIG. 10C is a view showing the alignment of a first hologram of a dual layer holographic color filter according to the present invention, in which reconstructed images of the first hologram are suitable for an transmissive LCD equipped with color filters arranged in the form of a delta;

FIG. 11 is a view showing a liquid crystal display that employs a dual layer holographic color filter according to the present invention and includes a color filter; and

FIG. 12 is a view showing a liquid crystal display that employs a dual layer holographic color filter according to the present invention and does not include a color filter.

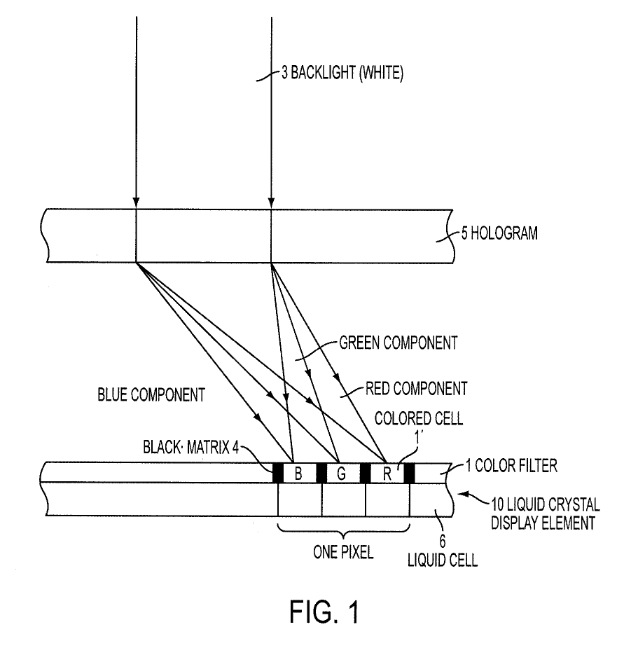

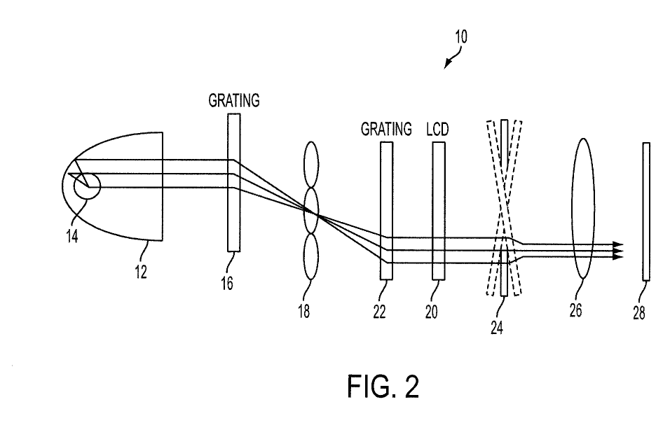

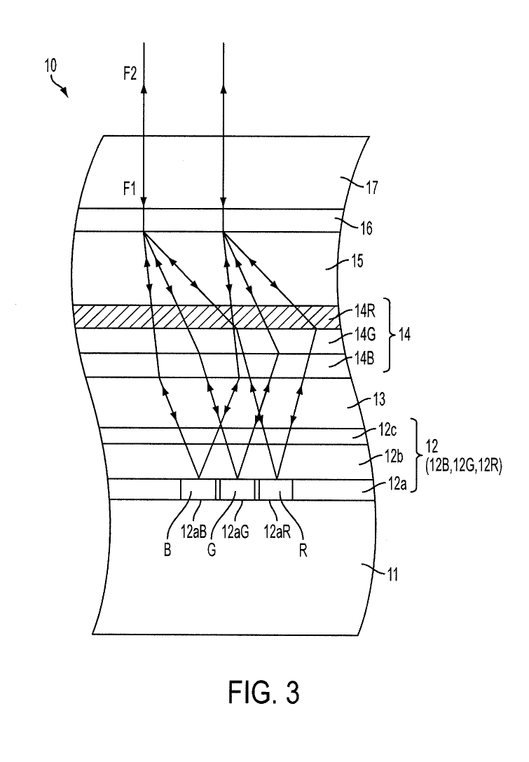

### DETAILED DESCRIPTION

Hereinafter, preferred embodiments of the present invention will be described in detail with reference to accompanying drawings.

According to the embodiment, wavelengths are split into each other corresponding to the interval between R, G, and B colored cells of a liquid crystal display (LCD), and a holographic color filter is interposed between a backlight unit and the LCD, in which the holographic color filter includes two holograms to correct wavelengths having different optical paths such that the wavelengths travel in the same direction.

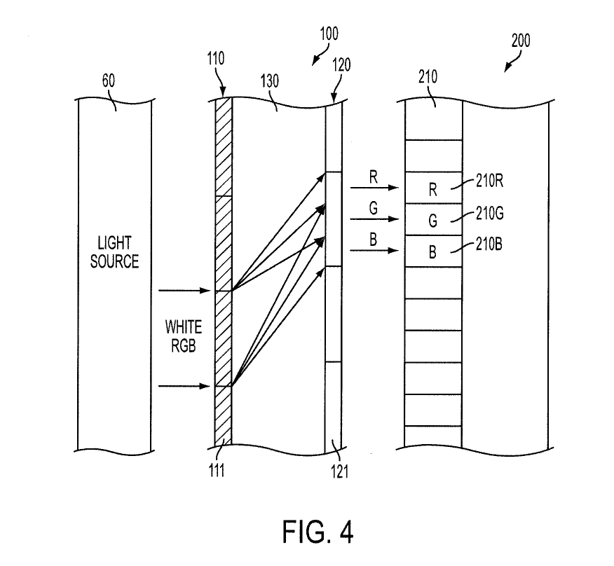

As shown in FIG. 4, a dual layer holographic color filter 100 according to the embodiment is interposed between a light source 60 and an LCD 200. The holographic color filter 100 includes a first hologram 110 provided at the side of the light source 60, a second hologram 120 provided at the side of the LCD 200, and a substrate 130 including glass or plastic between the first and second holograms 110 and 120.

A color filter 210 coupled with the LCD 200 has unit pixels including red, green, and blue colored cells 210R, 210G, and 210B. The red colored cell 210R transmits only a red wavelength of incident light. The green colored cell 210G transmits only a green wavelength of the incident light, and the blue colored cell 210B transmits only a blue wavelength of the incident light. Then, after the incident light passes through the LCD 200, color is realized through color combination.

The first hologram 110 includes a plurality of transparent transmissive first hologram pieces 111 having the size of a unit pixel. The first hologram piece 111 includes a surface-relief hologram having a multi-layer formed through a computer generated hologram (CGH) scheme designed to exactly match with the size of a unit pixel on the surface of the second hologram 120 or a volume hologram directly recorded on a holographic recording material according to the material and the thickness of the substrate 130.

The first hologram 110, which is positioned at the side of the light source 60, includes the first hologram pieces 111 designed to reproduce a linear-type image having a length shorter than that of the green colored cell 210G in a longitudinal direction on the lateral side of the green colored cell 210B of the second hologram 120 if green light, which is used for designing the CGH scheme or recording the volume hologram, is used as record light.

When comparing with the green record light, a red light having a longer wavelength is diffracted at a greater angle so that a longer image is made on the red sub pixel 210R, and a blue light having a smaller wavelength is diffracted at a smaller angle so that a shorter image is made on the blue colored cell 210B. Accordingly, white light, which has RGB wavelengths and has passed through the first hologram 110, is subject to color separation due to light diffraction such that only a wavelength corresponding to each of the RGB colored cells is incident on the surface of the second hologram 120.

The second hologram 120 includes a plurality of a transparent transmission-type second hologram pieces 121 having the size of a unit pixel to correct the directions of RGB wavelengths traveling in different directions after having been subject to color separation by the first hologram 110. Accordingly, light is incident onto the LCD 200 in the same direction as that of original light of the light source 60 after passing through the dual layer holographic color filter 100. Therefore, chromatic dispersion caused when the dual layer holographic color filter 100 is inserted into a transmissive LCD and problems related to color combination can be solved. Similar to the first hologram piece 111, the second hologram piece 121 includes a surface-relief hologram having a multi-layer based on the CGH scheme or a volume hologram directly recorded on a holographic recording material.

The second hologram pieces 121 must be placed in an on-axis with respect to the color filter 210 such that the R, G, and B light the traveling directions of which have been corrected through the second hologram pieces 121 can be incident onto the colored cells 210R, 210G, and 210B, respectively. The first hologram pieces 111 are placed in an off-axis with respect to the second hologram pieces 121 based on diffraction angles of RGB wavelengths such that diffracted wavelengths reach to corresponding second hologram pieces 121. The number of the first and second hologram pieces 111 and 121 may correspond to integer times the number of unit pixels according to design and manufacturing schemes.

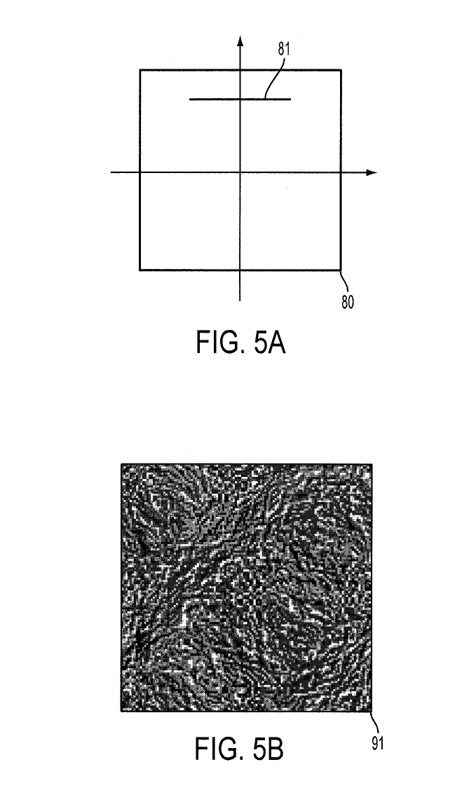

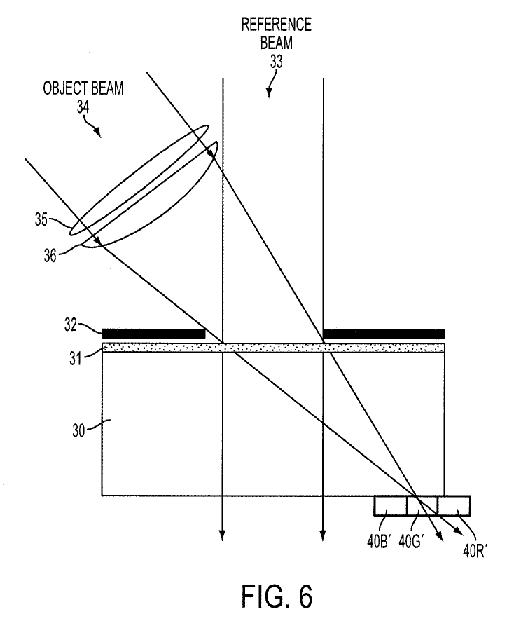

As shown in FIGS. 5A and 6, the first hologram pieces 111 according to the present invention may be manufactured by using a surface-relief hologram having a multi-layer based on the CGH scheme or a volume hologram directly recorded on a holographic recording material.

Hereinafter, a method of manufacturing the surface-relief hologram having the multi-layer based on the CGH scheme will be described in more detail with reference to FIG. 5A.

When RGB central wavelengths (λR, λG, and λB) have a diffraction angle (θ including diffraction angles θr, θg, and θb of λR, λG, and λB, respectively) with respect to a wavelength (λ) of a whole visible ray from the light source 60 according to Equation 1 (a diffraction equation), the size d of the minimum hologram pattern and the position of a reconstructed image 81 from a central portion of a target image 80 are determined in such a manner that a distance between θr and θb becomes a distance between central portions of the colored cells 210R and 210B after the light has passed through the substrate 130 having a thickness D.

The size of the target image 80 including the reconstructed image 81 is set to the size of a single pixel, and “m” is a diffraction order having a value of “1” in a multi-layer. As shown in FIG. 5B, a hologram pattern 91 is formed through the CGH scheme by taking the size of the target image 80, the size of the pattern, and the position of the reconstructed image 81 into consideration. Then, a typical surface-relief hologram having a multi-layer is formed according to the height of each pixel.

d sin θ=mλ Equation 1

FIG. 6 is a view showing a method of directly recording a volume hologram on a holographic recording material according to the present invention.

Referring to FIG. 6, if record light is a laser beam of a green wavelength λG, an aperture is disposed on the substrate 130 coated with a holographic recording material 31 reacting with the laser beam by taking a shadow area of an object beam incident in an oblique direction into consideration, in which the aperture has a transparent area slightly wider than a unit pixel and a remaining area through which light does not pass. Then, a hologram is recorded on the holographic recording material by crossing a reference beam 33 and the object beam 34 after dividing the laser beam into the object beam 34 and the reference beam 33. Although the reference beam 33 represents a traveling direction of light of the light source 60, and generally travels straight ahead, the reference beam 33 may have a divergence form or a convergence form according to radiation patterns of the light. An incident angle of the object beam 34 is determined to allow the object beam 34 to be directed towards a specific position with respect to the record light in such a manner that reconstructed images of the red and blue wavelengths λR and λB are placed at central portions of virtual colored cells 210R′ and 210B′ according to equation 1 after the object beam 34 has passed through the substrate 130 having the thickness D. Actually, virtual colored cells 210R′, 210G′, and 210B′ are places in which the second hologram pieces 121 are positioned. The object beam 34 branching from the laser beam forms a linear focus at the center of the virtual green colored cell 210G′ through the combination of a typical lens 35 to collect light in all directions and a lenticular lens 36 to collect light traveling in one direction. Accordingly, if white light is incident onto the hologram, red and blue wavelengths are on and under the green wavelength used for record, respectively, at an interval corresponding to the size of one colored cell.

RGB central wavelengths of light used for a transmissive LCD have wavelength intervals and intensities different from each other. Accordingly, the light, which has passed through the first hologram pieces 111, has been spatially split into each other due to diffraction, and then has been incident onto each colored cell of the color filter 210, may have an eccentric central wavelength and different intensities. An amount of light incident onto each colored cell can be adjusted according to the convenience of a user by adjusting the length and the position of a reconstructed image for reference light used in the design of the first hologram pieces 111 based on the bandwidth and the intensity ratio of the RGB central wavelengths of the light from the light source 60.

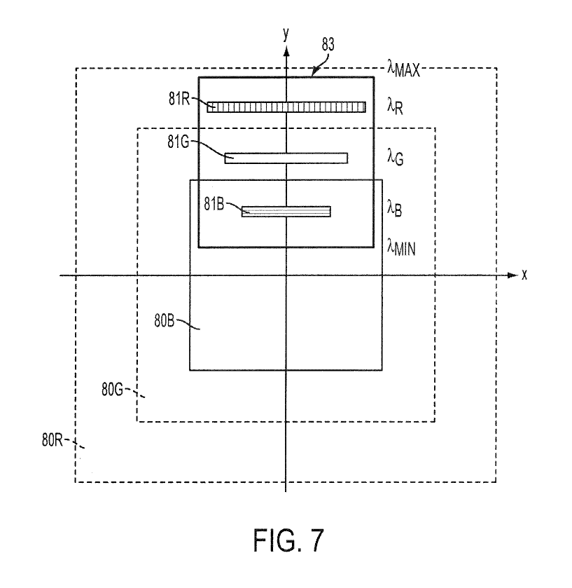

As shown in FIG. 7, white light that has passed through the first hologram 110 manufactured in the above method has diffraction angles varied according to wavelength lengths, so that the size of the reconstructed area 80 and the position of the reconstructed image 81 are changed. However, the ratio of the reconstructed image 81 to the whole reconstructed area 80 is constant regardless of the wavelength. Accordingly, a red reconstructed area 80R and a red reconstructed image 81R are formed with respect to the red wavelength λR. A green reconstructed area 80G and a green reconstructed image 81G are formed with respect to the green wavelength λG. A blue reconstructed area 80B and a blue reconstructed image 81B are formed with respect to the blue wavelength λB. The reconstructed image 81 of the first hologram piece 111 is formed such that light passing through the unit pixel is convergent into one line regardless of wavelengths. Accordingly, the absolute positions of the reconstructed image 81 are changed in the shape of a trapezoid according to wavelengths, in which the absolute positions of the reconstructed image 81 are changed corresponding to a short convergence line made at a lower portion by a short wavelength λMIN and a long convergence line made at an upper area by a long wavelength λMAX. The distribution of the reconstructed image 81 is made by transforming a spectral distribution of a visible ray region of the white light into a spatial spectrum. The distribution of the reconstructed image 81 represents the intensity distribution of all wavelengths of the light from the light source 60 without the overlap between wavelengths in which there is no variation in the whole amount of light. The size of a reconstructed image 83 for all wavelengths represented by a bold line is designed to be identical to the size of a unit pixel.

Referring to FIG. 4, if light, which has been diffracted in a pixel unit by the first hologram 110 and then passed through the substrate 130, travels in different directions according to the wavelengths to be incident onto the color filter 210 or the LCD 200, chromatic dispersion may occur. Accordingly, problems may occur in color combination. In order to solve the problems, a traveling direction of each wavelength of the light must be corrected. In addition, in order to minimize the variation in an optical characteristic in addition to the increase of brightness due to the insertion of the holographic color filter 210, the light preferably has the same optical characteristic as that of light from the light source 60. Such an operation is performed by the second hologram 120 including a plurality of the second hologram pieces 121.

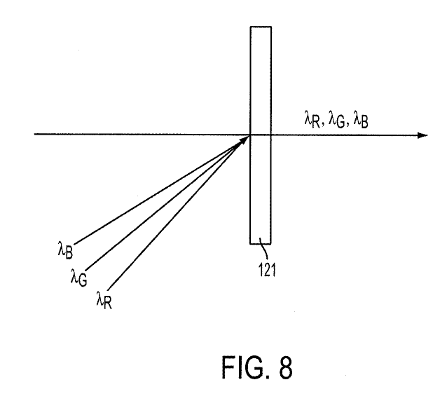

As shown in FIG. 8, the second hologram 120 includes the second hologram pieces 121 having the size of a unit pixel to allow the RGB central wavelengths λR, λG, and λB to travel in a direction perpendicular to the surface of the second hologram 120 (x-y plan). The red, green, and blue wavelengths λR, λG, and λB split by the first hologram pieces 111 are diffracted in upper, central, and lower directions, respectively. For example, when the second hologram piece 121 is constructed such that the green wavelength λG incident at a diffraction angle of θg travels in a direction perpendicular to the surface of the second hologram piece 121, the second hologram 120 diffracts the RGB central wavelengths—incident at different angles in the same direction—to the same direction similarly to the first hologram 110 diffracting the RGB central wavelengths at different angles. Accordingly, if the second hologram 120 including the second hologram pieces 121 manufactured in the method of FIGS. 5 to 6 is formed at an opposite side of the first hologram 110 with respect to the substrate 130, chromatic dispersion is prevented. In addition, the traveling direction of the RGB central wavelengths is identical to that of the light from the light source 60, so that conventional color combination is possible.

The dual layer holographic color filter 100 according to the present invention performs a filtering operation due to the distribution of a spatial spectrum instead of a filtering operation due to pigment layers R, G, and B of the color filter 210. Accordingly, light is not absorbed in the color filter 210, and RGB bandwidths are not overlapped with each other, thereby realizing a transmissive LCD having enhanced luminance and superior color reproduction. The bandwidth and intensity of each wavelength passing through each pigment layer of the color filter 210 can be adjusted by changing the grating period of the first hologram 110 due to the spectrum distribution of wavelengths from the light source 60. The wavelength that has diffracted out of the corresponding pigment layer is blocked by an adjacent pigment layer so that more uniform intensity distribution of the wavelengths can be obtained.

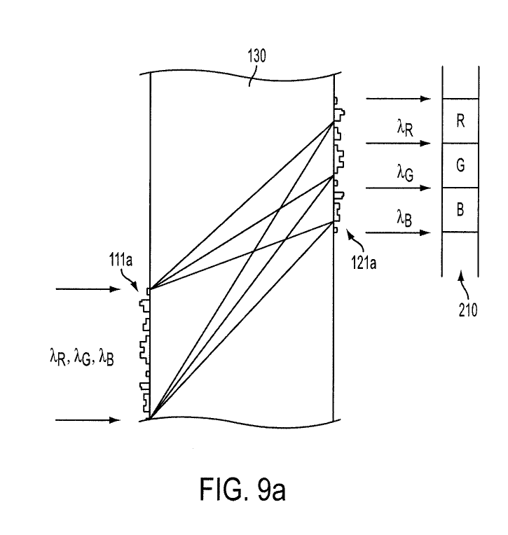

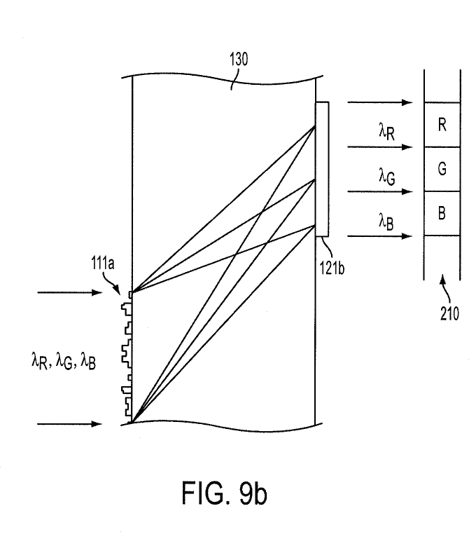

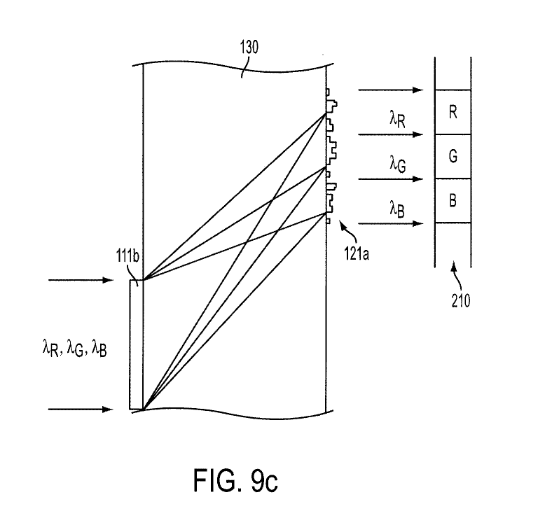

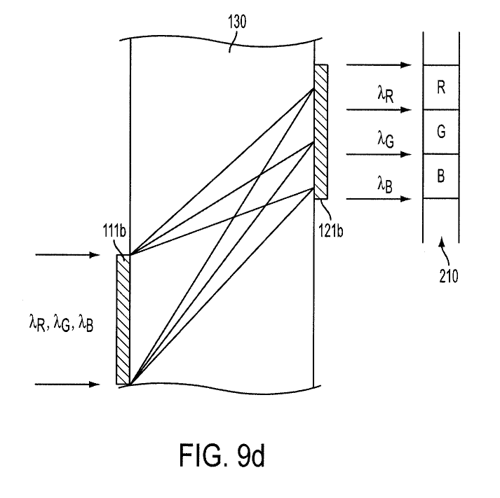

As described above, the first and second holograms 110 and 120 can be manufactured by using a surface-relief hologram and a volume hologram. The dual layer holographic color filter 100 according to the present invention may have four types as shown in FIGS. 9A to 9D.

FIG. 9A is a view showing a case in which both of the first and second holograms 110 and 120 include surface-relief holograms 111a and 121a, and FIG. 9B is a view showing a case in which the first hologram 110 includes the surface-relief hologram 111a, and the second hologram 120 includes a volume hologram 121b. FIG. 9C is a view showing a case in which the first hologram 110 includes the volume hologram 111h, and the second hologram 120 includes the surface-relief hologram 121a, and FIG. 9D is a view showing a case in which both of the first and second holograms include the volume holograms 111b and 121b. The dual layer holographic color filter 100 performs the same operation regardless of the above combination. However, in the case of the surface-relief hologram, if the number of layers is less, efficiency may be degraded. In addition, if the number of layers is great, manufacturing the surface-relief hologram is difficult. Accordingly, the volume hologram directly recorded on a recording material by using a laser represents a superior characteristic in terms of efficiency and stability.

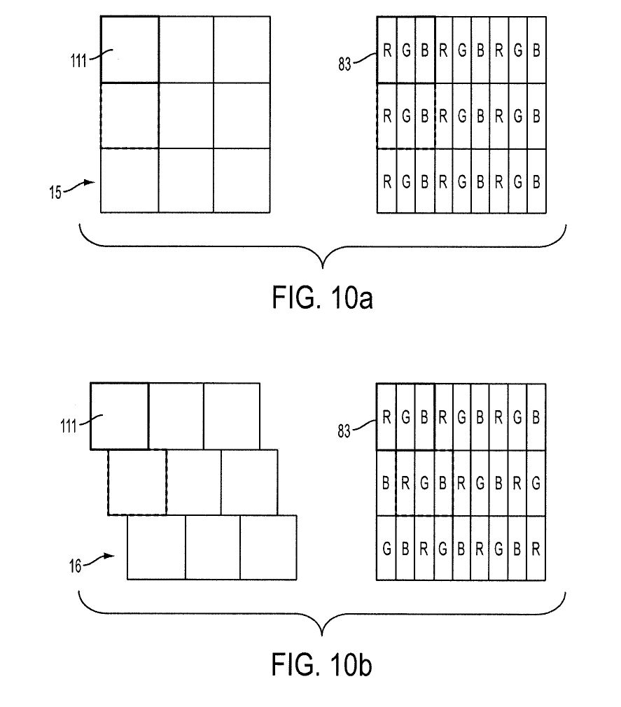

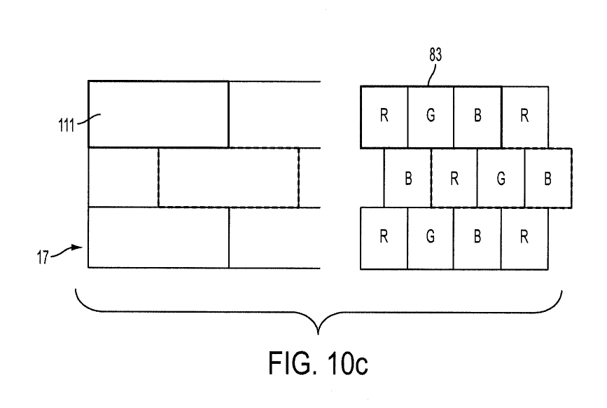

A commercialized LCD has various color filter arrays for the purpose of color combination, and a procedure of manufacturing a dual layer holographic color filter suitable for the LCD is shown in FIGS. 10A to 10C. In the following description, the same numerals will be assigned to elements performing the same operations, and the first and second hologram pieces 111 and 121 one-to-one correspond to each other in an off-axis. Accordingly, the operating characteristic of the dual layer holographic color filter will be described by using only the alignment of the first hologram pieces 111. In the reconstructed image 83 for all wavelengths, parts incident into pigment layers are expressed as R, G, and B similarly to the pigment layers. In addition, an optical device for color separation is rotated by 90 degrees according to the alignment of the pigment layers.

FIG. 10A shows a stripe-type first hologram 15 suitable for an LCD equipped with color filters arranged in the form of a stripe. The first hologram pieces 111, which are designed such that the reconstructed image 83 for all wavelengths of the first hologram pieces 111 have the size identical to that of the RGB pigment layers, are arranged in the same form as that of the color filters. FIG. 10B shows a mosaic-type first hologram 16 suitable for an LCD equipped with color filters arranged in the form of a mosaic. The first hologram pieces 111, which are designed such that the reconstructed image 83 for all wavelengths of the first hologram pieces 111 have the size identical to that of the RGB pigment layers, are shifted from line to line corresponding to the width of one pigment layer in the same manner as that of the color filters arranged in the form of the mosaic.

FIG. 10C shows a delta-type first hologram 17 suitable for an LCD equipped with color filters arranged in the form of a delta. The first hologram pieces 111, which are designed such that the reconstructed image 83 for all wavelengths of the first hologram pieces 111 have the size identical to that of the RGB pigment layers, are arranged through shift by a half of the whole width of the first hologram pieces 111 in each line in the same manner as that of the color filter arranged in the form of the delta. Since the mosaic-type first hologram increases the interval between the RGB central wavelengths in the reconstructed image, the mosaic-type first hologram pieces must be designed such that the size d of the minimum pattern can be reduced, and the reconstructed image can be placed in an outer region as possible.

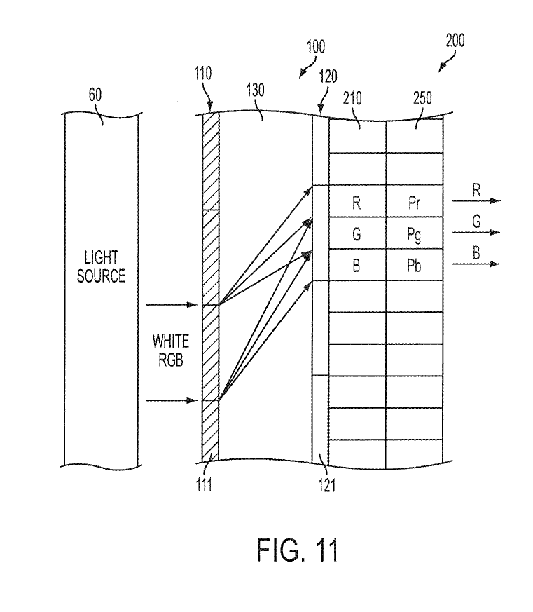

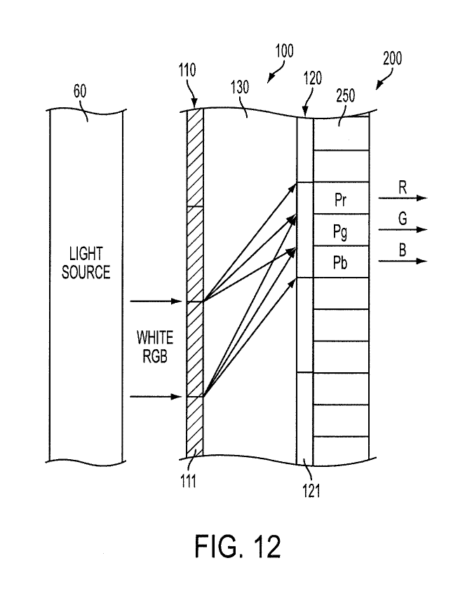

Although the dual layer holographic color filter 100 according to the present invention is adjacent to the LCD 200, the holographic color filter 100 is be manufactured when the LCD 200 is manufactured, so that the holographic color filter 100 and the LCD 200 can be constructed in one module. FIGS. 11 and 12 are sectional views showing a transmissive LCD including the color filter 210 and a transmissive LCD that does not include the color filter 210 when the holographic color filter 100 is employed for the LCD 200.

Referring to FIG. 11, according to the second embodiment of the present invention, the holographic color filter 100 is employed for the LCD 200 including the color filter 210. After providing the first hologram 110 at the side of the light source 60 at one side of the substrate 130 and providing the second hologram 120 at the side of the LCD 200, the color filter 210 is provided between the second hologram 120 and the liquid crystal 250 of the LCD 200.

Referring to FIG. 12, according to the third embodiment of the present invention, the dual layer holographic color filter 100 is employed for the LCD 200 that does not include the color filter 210. After providing the first hologram 110 at the side of the light source 60 at one side of the substrate 130 and providing the second hologram 120 at an opposite side of the substrate 130 adjacent to the liquid crystal 250, such that the dual layer holographic color filter 100 serves as a color filter of the LCD 200.

As described above, the dual layer holographic color filter 100 according to the second and third embodiments of the present invention distributes wavelengths of white light, which has been incident onto the first hologram 110, over a space having the size of a unit pixel, the substrate provides a diffraction space, and the second hologram recovers the direction of wavelengths that have been split by the first hologram to an original direction. Accordingly, problems do not occur in color combination.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A dual layer holographic color filter, comprising:
a first hologram adjacent to a light source and including a plurality of first hologram pieces to distribute wavelengths of white light to a space having a size of a unit pixel;
a substrate adjacent to the first hologram to support the first hologram and providing a diffraction space; and
a second hologram adjacent to a liquid crystal display to recover a direction of wavelengths split by the first hologram into an original direction such that only a wavelength corresponding to each colored cell is incident onto the colored cell, thereby preventing problems in color combination.

2. The dual layer holographic color filter of claim 1, wherein the first hologram includes a plurality of transparent transmissive hologram pieces having a size of a unit pixel.

3. The dual layer holographic color filter of claim 1, wherein the first hologram pieces constituting the first hologram are manufactured by a CGH design scheme or a volume hologram recording scheme such that one of red, green, and blue wavelengths is used as reference light, a wavelength longer than the reference light is diffracted at a greater angle, and a wavelength shorter than the reference light is diffracted at a small angle.

4. The dual layer holographic color filter of claim 1, wherein the second hologram is manufactured such that red, green, and blue central wavelengths, which are incident at different angles after passing through the first hologram and having been diffracted in the substrate, are diffracted in a direction identical to a direction of light from the light source.

5. The dual layer holographic color filter of claim 1, wherein the second hologram adjacent to the liquid crystal display includes an array of a plurality of transmissive transparent second hologram pieces having a size of a unit pixel.

6. The dual layer holographic color filter of claim 5, wherein the second hologram pieces are positioned in an on-axis with pixels of the liquid crystal display.

7. The dual layer holographic color filter of claim 2, wherein the first hologram pieces are positioned in an off-axis with the second hologram pieces based on diffraction angles at which diffracted wavelengths reach the second hologram pieces corresponding to the wavelengths.

8. The dual layer holographic color filter of claim 2, wherein the first and second hologram pieces correspond to integer times unit pixels.

9. The dual layer holographic color filter of claim 1, wherein both of the first and second hologram pieces include a surface-relief hologram.

10. The dual layer holographic color filter of claim 1, wherein the first hologram piece includes a surface-relief hologram, and the second hologram piece includes a volume hologram.

11. The dual layer holographic color filter of claim 1, wherein the first hologram piece includes a volume hologram, and the second hologram piece includes a surface-relief hologram.

12. The dual layer holographic color filter of claim 1, wherein both of the first and second hologram pieces include a volume hologram.

13. A liquid crystal display comprising a color filter, wherein a dual layer holographic color filter having a structure claimed in claim 1 is interposed between a light source and the color filter.

14. The liquid crystal display of claim 13, wherein first hologram pieces are arranged in a same form as an arrangement form of color filters, in which the first hologram pieces are designed such that reconstructed images for all wavelengths of the first hologram pieces have a size identical to that of RGB pigment layers.

15. The liquid crystal display of claim 13, wherein first hologram pieces are arranged through shift by a width of one pigment layer in each line in a manner identical to a manner of color filters arranged in a mosaic form, in which the first hologram pieces are designed such that reconstructed image for all wavelengths of the first hologram pieces have a size identical to a size of RGB pigment layers.

16. The liquid crystal display of claim 13, wherein first hologram pieces are arranged through shift by a half of a whole width of the first hologram pieces in each line in a manner identical to a manner of color filters arranged in a delta form, in which the first hologram pieces are designed such that reconstructed images for all wavelengths of the first hologram pieces have a size identical to a size of RGB pigment layers.

17. A liquid crystal display comprising a color filter, wherein a dual layer holographic color filter having a structure claimed in claim 1 is formed next to the color filter of the liquid crystal display.

18. A liquid crystal display that is not equipped with a color filter, wherein a dual layer holographic color filter having a structure claimed in claim 1 is interposed between a light source and a liquid crystal of the liquid crystal display.
